(19) United States
(12) Patent Application Publication
(10) Pub. No.: US 2011/0069724 A1
(43) Pub. Date: Mar. 24, 2011

(54) Optical fiber for sum-frequency generation

(75) Inventors: Simon Richard, Villebon-Sur-Yvette (FR); Ekaterina Burov, Boulogne-Billancourt (FR); Alain Pastouret, Massy (FR); Olivier Cavani, Angervilliers (FR)

(73) Assignee: DRAKA COMTEQ, B.V., Amsterdam (NL)

(21) Appl. No.: 12/887,813

(22) Filed: Sep. 22, 2010

Related U.S. Application Data
(60) Provisional application No. 61/254,924, filed on Oct. 26, 2009.

(30) Foreign Application Priority Data
Sep. 22, 2009 (FR) 09/04512

(51) Int. Cl. H01S 3/30; G02B 6/02; H01S 3/067; B82Y 20/00

(52) U.S. Cl. 372/6; 385/122; 359/341.1; 977/951; 977/810; 977/779; 977/773; 977/902

(57) ABSTRACT

The present invention embraces an optical fiber that includes a central core to transmit optical signals and an optical cladding surrounding the central core to confine transmitted optical signals. The optical fiber typically includes metallic nanostructures for increasing second-order nonlinearity effects. The optical fiber typically has a refractive index profile that ensures a phase-matching condition.

### CROSS-REFERENCE TO PRIORITY APPLICATIONS

This application claims the benefit of commonly assigned pending French Application No. 09/04512 for a “Fiber Optique Pour la Génération de Fréquence Somme et son Procede de Fabrication” (filed Sep. 22, 2009, at the National Institute of Industrial Property (France)), which is hereby incorporated by reference in its entirety.

This application further claims the benefit of commonly assigned U.S. Patent Application No. 61/254,924 for a “Fiber Optique Pour la Génération de Fréquence Somme et son Procede de Fabrication” (filed Oct. 26, 2009), which is hereby incorporated by reference in its entirety.

### FIELD OF THE INVENTION

The present invention relates to the field of optical fibers and, more particularly, to an optical fiber adapted to generate a sum frequency from two incident electromagnetic waves.

### BACKGROUND

Typically, lasers emitting in the visible spectrum can be employed in biotechnology instruments using laser-induced fluorescence and in light diffraction techniques. Other applications include graphical processing, image display, or applications for the semiconductor industry (e.g., digital television).

A laser that emits in the visible spectrum can be a gas laser. This kind of laser typically employs argon for emitting a wavelength of 490-510 nanometers, copper vapor for emitting a wavelength of 510-570 nanometers, or helium-neon for emitting a wavelength of 633 nanometers. These are first-generation lasers whose basic principle here consists in discharging an electric current through a gas to produce light. The gas laser, however, has a limited lifetime and requires a bulky container. It additionally suffers from limited electrical efficiency, complexity of maintenance, and the need to dissipate heat energy which limit the development and application of the gas laser.

A laser that emits in the visible spectrum can also be a semiconductor (III-V) technology-based laser diode. The laser diode employs inter-band electron transitions in semiconductor materials. Lasers that emit in the red range have been available commercially from several manufacturers for more than 20 years. As a replacement for argon-based lasers for several applications, there has been an emergence of commercial laser diodes that emit at a 488-nanometer wavelength. Nevertheless, such laser diodes are somewhat limited with regard to the output power that can be achieved in single mode operation. Further, certain green and yellow wavelengths cannot be obtained.

A laser that emits in the visible spectrum can be a frequency doubling laser. Typically, a frequency doubling laser emitting in the visible spectrum employs an infrared laser source whose frequency is doubled using a nonlinear medium. The infrared laser source in the 900-nanometer to 1300-nanometer range can be a laser diode. The source can also be a diode or laser-pumped solid-state laser or DPSS (Diode Pumped Solid State Laser), for example of the Nd:YVO4 or Nd:YAG kind. One can also employ an optically pumped semiconductor laser or a fiber laser (e.g., a ytterbium-doped fiber laser). In general, the nonlinear medium employed for frequency doubling should exhibit a second-order nonlinearity characteristic, in other words, a sufficiently high χ(2) parameter. Typically, a nonlinear crystal (e.g., LiNbO₃, KDP, KTP, BBO, LBO) is used, or a silica fiber whose nonlinearity is permanently induced by applying an electric field at high temperature. As will be understood by those having ordinary skill in the art, KDP is monopotassium phosphate, KTP is potassium titanyl phosphate, BBO is beta barium borate, and LBO is lithium triborate.

The efficiency of energy conversion depends on the nonlinear medium. In effect, the principal drawbacks of the frequency doubling laser originate from the nonlinear medium employed.

First, the nonlinear crystal has a limited length and, as a consequence, a limited total nonlinear gain. Thus, to obtain reasonable conversion efficiencies under low peak power conditions, it is necessary to come up with complex schemes for intra-cavity wavelength conversion. Second, the polarization of an optical fiber necessitates a local secondary treatment of the optical fiber, which only makes it possible to obtain samples of nonlinear optical fiber several centimeters long with poor nonlinearity (e.g., around 0.01 pm/V, which is 100 times less than that for a nonlinear crystal).

For efficient sum-frequency generation from two frequencies ω₁ and ω₂, the waves also need to be phase tuned (i.e., demonstrate zero or negligible phase mismatch Δk). Phase mismatch Δk is defined by the equation Δk=k3−k1−k2, in which k1 and k2 are the wave vectors of the two incident waves and k3 is the wave vector of the third output wave.

In an optical fiber, the wave vector k is given by the following equation:

$$k = \frac{2 π {n}_{eff} ( λ )}{λ}$$

wherein λ is the wavelength, and n_{eff}(λ) is the effective refractive index for wavelength λ. The effective refractive index n_{eff} is a function of the optical fiber refractive index profile and the mode of propagation of the wave in the fiber.

Coherence length is another parameter making it possible to describe the efficiency of energy conversion of ω1 and ω2 waves to the ω3 wave. Coherence length Lc is defined by the relation:

$$Lc = \frac{π}{Δ k}$$

The article “Second harmonic generation from ellipsoidal silver nanoparticles embedded in silica glass” by A. Podlipensky et al., published in Optics Letters, Vol. 28, No. 9, May 1, 2003, describes frequency doubling in a silica material containing two doped layers of silver nanoparticles exhibiting a second order nonlinear effect. This article, however, concerns the properties of a bulk material and does not include any mention of a guiding structure.

Insertion of metallic nanostructures into a fiber to improve nonlinearity properties is also known. For example, the article “Ag nanocrystal-incorporated germano-silicate optical fiber with high resonant nonlinearity”, by Aoxiang Lin et al., Applied Physics Letters vol. 93, 021901, 2008, discusses the insertion of silver nanoparticles to obtain a third order nonlinearity in a germanium-doped silica optical fiber. This publication, however, does not provide details of the profile of a silica fiber in a way that achieves second-order nonlinearity properties and phase matching between the waves present in the process of generating the sum frequency.

Therefore, a need exists for an optical fiber having second-order nonlinearity (i.e., a sufficiently high χ(2) parameter) that makes possible the achievement of sum-frequency generation with efficient energy conversion.

### SUMMARY

Accordingly, in one aspect, the present invention embraces an optical fiber that includes metallic nanostructures (e.g., at least one nanoparticle) for boosting the second-order nonlinearity. Typically, the optical fiber has a refractive index profile that ensures a phase matching condition. Nanostructures have at least one dimension in the range of the nanometric scale (e.g., a dimension between about 1 nanometer and 100 nanometers).

In an exemplary embodiment, the optical fiber includes a central core, which is capable of transmitting an optical signal, and a surrounding optical cladding (e.g., an outer optical cladding), which is capable of confining the transmitted optical signal within the central core. The optical fiber may be composed of a dielectric matrix that includes metallic nanostructures that increase the second order nonlinearity property of the optical fiber. Typically, the phase mismatch between two incoming waves in the optical fiber and an output wave of the optical fiber, defined by Δk=k3−k1−k2, is less than 10⁴ radians per meter, where k1 and k2, respectively, are the wave vectors of the first and the second incoming waves, and k3 is the wave vector of the output wave.

In an exemplary embodiment, the dielectric matrix of the central core (i.e., the core dielectric matrix) is silica-based.

In another exemplary embodiment, the dielectric matrix of the optical cladding (i.e., the cladding dielectric matrix) is silica-based.

In another exemplary embodiment, the dielectric matrix of the central core and/or the dielectric matrix of the optical cladding includes silica doped with germanium (Ge), phosphorus (P), fluorine (F), boron (B), aluminum (Al), tantalum (Ta), or tellurium (Te), or combinations thereof.

In yet another exemplary embodiment, the optical fiber's central core contains metallic nanostructures.

In yet another exemplary embodiment, the optical fiber's metallic nanostructures are present in the optical fiber's mode field (e.g., within the optical cladding in the immediate vicinity of the core).

In yet another exemplary embodiment, the metallic nanostructures include gold (Au), silver (Ag), copper (Cu), aluminum (Al), tungsten (W), nickel (Ni), palladium (Pd), rhodium (Rh), iridium (Ir), ruthenium (Ru), molybdenum (Mo), osmium (Os), or platinum (Pt), or combinations thereof.

In yet another exemplary embodiment, the metallic nanostructures have a melting temperature greater than or equal to 950° C.

In yet another exemplary embodiment, the metallic nanostructures have a temperature of evaporation greater than or equal to 2100° C.

In yet another exemplary embodiment, the metallic nanostructures have an oval shape whose minor diameter is oriented perpendicularly to the axis of the optical fiber.

In yet another exemplary embodiment, the minor diameter of the metallic nanostructures is typically between about 1 nanometer and 200 nanometers (e.g., between about 5 nanometers and 100 nanometers).

In yet another exemplary embodiment, the major diameter of the metallic nanostructures is between about 1 nanometer and 200 microns.

In yet another exemplary embodiment, the metallic nanostructures have a ratio of the major diameter to the minor diameter of between about 1 and 2,000 (e.g., between 1 and 100).

In yet another exemplary embodiment, the diameter of the central core is between 2 and 10 microns (e.g., between 2 and 3 microns).

In yet another exemplary embodiment, the refractive index difference Dn between the optical fiber's central core and the optical fiber's optical cladding is between 0.3 and 3 percent of the index of the optical cladding (e.g., between 2 and 2.5 percent).

In yet another exemplary embodiment, the optical fiber's core is tapered (e.g., profiled) in the longitudinal direction of the optical fiber between two ends of the optical fiber. Typically, the ratio of the central core's diameter at an end of the optical fiber to the central core's diameter at the other end of the optical fiber is between about 1 and 3 (e.g., between 1 and 1.5).

In yet another exemplary embodiment, the coherence length (Lc=π/Δk) is greater than 300 microns (e.g., greater than 10 centimeters).

In another aspect, the present invention embraces an optical amplifier that includes at least a portion of an optical fiber having a central core, an optical cladding, and metallic nanostructures.

In yet another aspect, the present invention embraces a laser that includes at least a portion of an optical fiber having a central core, an optical cladding, and metallic nanostructures. In one embodiment, the laser includes two pump-laser sources. In another embodiment, the laser includes a portion of an optical fiber performing mode conversion. In yet another embodiment, the laser emits light having a wavelength in the visible range.

The foregoing illustrative summary, as well as other exemplary objectives and/or advantages of the invention, and the manner in which the same are accomplished, are further explained within the following detailed description and its accompanying drawings.

### BRIEF DESCRIPTION OF THE DRAWINGS

FIG. 1 schematically depicts an exemplary optical fiber that includes metallic nanostructures.

FIG. 2 schematically depicts a diagram showing the process of sum-frequency generation in an exemplary optical fiber.

FIG. 3 schematically depicts the refractive index profile of an exemplary optical fiber.

FIG. 4 schematically depicts a source frequency doubling laser that includes an exemplary optical fiber.

FIG. 5 schematically depicts a sum-frequency-generating laser that includes an exemplary optical fiber.

### DETAILED DESCRIPTION

The present invention embraces an optical fiber having second-order nonlinearity (i.e., a sufficiently high χ(2) parameter) that makes it possible to achieve sum-frequency generation (SFG) with efficient energy conversion.

The optical fiber of the present invention typically includes a central core to provide optical signal transmission and an optical cladding surrounding the central core. The optical cladding (e.g., an outer optical cladding) is typically adapted to confine the transmitted optical signal within the central core.

The present optical fiber is typically composed of a dielectric matrix that includes metallic nanostructures. The metallic nanostructures increase the second-order nonlinearity effect of the optical fiber.

In an exemplary embodiment of the present optical fiber, the phase mismatch between two waves entering the optical fiber and a wave exiting the optical fiber is less than 10⁴ radians per meter. The phase mismatch Δk is typically defined by the equation: Δk=k3−k1−k2, wherein k1 and k2 are the wave vectors of the first and second input waves respectively, and k3 is the wave vector of the output wave.

FIG. 1 schematically depicts an exemplary optical fiber 1 that includes metallic nanostructures 2 within the optical fiber's dielectric matrix 3.

An optical fiber 1 conventionally includes a central core 4, which transmits and/or amplifies an optical signal, and an optical cladding 5, which confines the optical signal within the central core 4. Accordingly, the refractive index of the central core n_{c} is typically greater than the refractive index of the outer cladding n_{g} (i.e., n_{c}>n_{g}). In the exemplary embodiment depicted in FIG. 1, the optical fiber 1 includes metallic nanostructures 2 within the central core 4.

As depicted in the exploded view within FIG. 1, the metallic nanostructures 2 are embedded within the optical fiber's dielectric matrix 3. The central sphere within FIG. 1's exploded view represents the metallic nanostructures 2 (Me as depicted).

An optical wave may be characterized by its angular frequency ω or by its wavelength λ, which are related by the following equation: ω=(2πc)÷λ, where c is the speed of light in a vacuum.

A nonlinear medium may be used to obtain an optical wave of angular frequency ω₃ from two incident optical waves of angular frequency ω₁ and ω₂. The angular frequency ω₃ is the sum of the angular frequencies ω₁ and ω₂. The aforementioned process is generally known as sum-frequency generation.

When the angular frequencies of the two incident optical waves are equal (i.e., where ω₁=ω₂), then the angular frequency of the output wave ω₃ is equal to 2ω₁ (i.e., λ₃=½λ₁), and the process is called frequency doubling. In this regard, frequency doubling is a particular type of sum-frequency generation. Energy conversion of the two waves of angular frequency ω₁ and ω₂ to the third wave of angular frequency ω₃ is most efficient when the waves are phase matched. Stated differently, energy conversion is most efficient when the two input waves and the output wave exhibit negligible phase mismatch Δk.

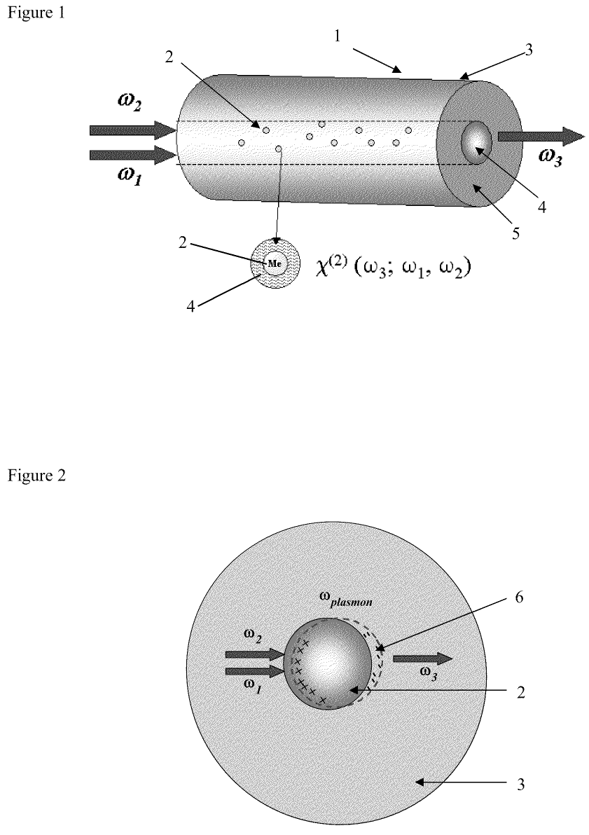

FIG. 2 schematically shows the process of sum-frequency generation in an exemplary optical fiber according to the present invention. A metallic nanostructure 2 is shown within a dielectric matrix 3 of an optical fiber. The metallic nanostructure 2 has an electron cloud 6 at its surface and positive charges within its inner portion.

The electron cloud 6 around the metallic nanostructure 2 has a collective excitation angular frequency called surface plasmon resonance frequency ωₚₗₐₛₘₒₙ. The electron cloud 6, therefore, can be excited via absorption of two incident photons having angular frequency ω₁ and ω₂, such that the sum of ω₁ and ω₂ (i.e., ω₁+ω₂) approximates surface plasmon resonance frequency ωₚₗₐₛₘₒₙ. The electron cloud 6 then loses excitation by emitting a photon of angular frequency ω₃ such that ω₃=ω₁+ω₂.

The gain represents the amplification factor for the output signal (i.e., having angular frequency ω₃) per unit of length. To have an overall positive gain, the amplification factor should be greater than the absorption by the metallic nanostructures 2 (i.e., the loss rate by absorption of signal ω₃ per unit of length). The value for the surface plasmon resonance frequency ωₚₗₐₛₘₒₙ should be chosen so that the generated angular frequency ω₃ corresponds to an overall positive gain.

The value of the surface plasmon resonance frequency ωₚₗₐₛₘₒₙ and the strength of the nonlinear effect with insertion of metallic nanostructures 2 depends on (i) the metal/dielectric matrix combination, (ii) the size of the nanostructures 2, (iii) the form of the nanostructures 2, (iv) the concentration of the nanostructures 2, and (v) the nature of the dielectric matrix 3.

Typically, the optical fiber's dielectric matrix 3 is silica. The central core's dielectric matrix is typically doped silica. In particular, the refractive index difference Dn of the central core 4 may be obtained by doping the central core's dielectric matrix 3 with germanium (Ge), phosphorus (P), fluorine (F), boron (B), aluminum (Al), tantalum (Ta), and/or tellurium (Te).

In some embodiments, the dielectric matrix of the central core and/or the dielectric matrix of the optical cladding is silica. Alternatively, the dielectric matrix of the optical cladding may be doped with germanium (Ge), phosphorus (P), fluorine (F), boron (B), aluminum (Al), tantalum (Ta), and/or tellurium (Te).

The size and the shape of the metallic nanostructures 2 may influence the value of the surface plasmon resonance frequency ωₚₗₐₛₘₒₙ and the shape of the absorption spectrum. Generally speaking, if the size of the nanostructures 2 is decreased in the electric field's axis of polarization, the surface plasmon resonance frequency ωₚₗₐₛₘₒₙ is shifted towards higher angular frequency values.

Thus, most of the metallic nanostructures 2 typically have an oval shape with a minor diameter a and a major diameter b. To the extent possible, it is desirable for more than 75 volume percent of the metallic nanostructures 2 (e.g., 90 volume percent or more) to have an oval-like shape (e.g., quasi-cylindrical with rounded edges). As noted, nanostructures have at least one nanometric dimension (e.g., a dimension between about 1 nanometer and 100 nanometers).

The minor diameter a is typically oriented perpendicularly to the optical fiber's longitudinal axis. The minor diameter a is typically between about 1 nanometer and 200 nanometers (e.g., between 5 and 100 nanometers). The major diameter b is typically between about 1 nanometer and 200 microns (e.g., between about 50 nanometers and 10 microns).

The ratio of the major diameter to the minor diameter (i.e., b/a) is typically between about 1 and 2000 (e.g., between 1 and 100, such as 5-50). The oval shape of the metallic nanostructures 2 can be controlled, for example, by adjusting fiber production parameters, notably during the fiber drawing stage.

As will be understood by those having ordinary skill in the art, a ratio b/a of 1 corresponds to a metallic nanostructure having a spherical shape. In this regard, employing metallic nanostructures 2 having a spherical shape (as illustrated in FIG. 2) is within the scope of the present invention.

Notwithstanding the foregoing, employing metallic nanostructures having other, less defined shapes is within the scope of the present invention.

In one exemplary embodiment, the metallic nanostructures are gold or silver elongated in the optical fiber's longitudinal axis with a minor diameter of about 50 nanometers and a major diameter of about 100 nanometers. The metallic nanostructures of this embodiment will typically have a surface plasmon resonance frequency ωₚₗₐₛₘₒₙ of about 400 nanometers.

Typically, the metallic nature of the nanostructures 2 allows them to withstand operating conditions in the optical-fiber production processes. For example, the metallic nanostructures 2 typically have a melting temperature greater than or equal to 950° C. (e.g., more than about 1,500° C.) and an evaporation temperature greater than or equal to 2100° C.

In some embodiments, the material of the metallic nanostructures 2 is compatible with the desired propagation parameters for the optical fiber (e.g., the optical fiber's refractive index or scattering losses).

Typically, the metallic nanostructures 2 may include gold (Au), silver (Ag), copper (Cu), aluminum (Al), tungsten (W), nickel (Ni), palladium (Pd), rhodium (Rh), iridium (Ir), ruthenium (Ru), molybdenum (Mo), osmium (Os), and/or platinum (Pt).

The metallic nanostructures are positioned in the optical signal path. For example, the metallic nanostructures can be inserted in the optical fiber's central core and/or in the optical cladding in the immediate vicinity of the central core (i.e., the portion of the optical cladding adjacent to the central core). To reduce negative effects that the metallic nanostructures may have on signal propagation (e.g., signal losses), the metallic nanostructure volumetric concentration in the core is typically less than about 2 percent. For example, the volumetric concentration of the metallic nanostructures in the core dielectric matrix may be less than about 2 percent (e.g., 0.1 volume percent to 1 volume percent). Similarly, the metallic nanostructure volumetric concentration in the cladding in the immediate vicinity of the core (e.g., the cladding dielectric matrix) is typically less than about 2 percent (e.g., at least about 0.001 volume percent, such as 0.01 volume percent to 1 volume percent).

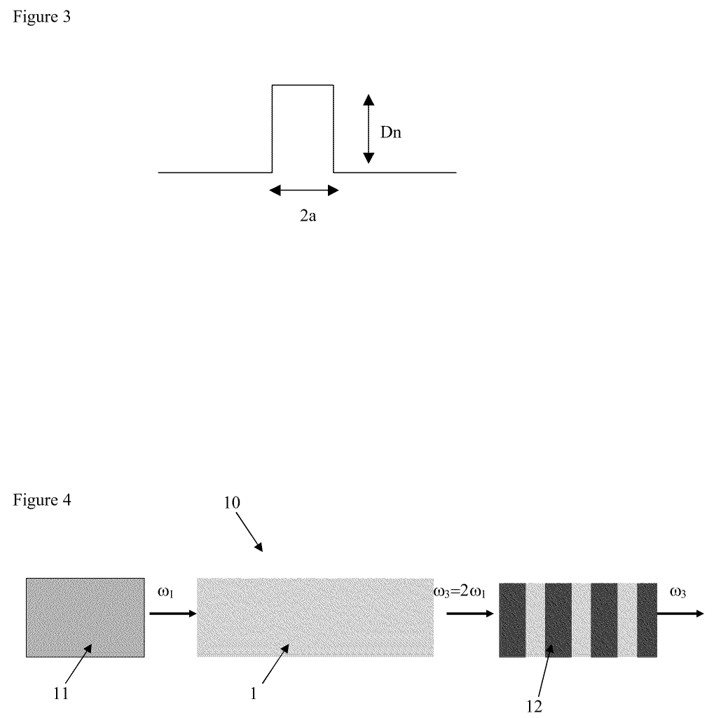

FIG. 3 schematically depicts the refractive index profile of an exemplary optical fiber. The central core of the optical fiber has a diameter 2a and a refractive index difference Dn with respect to the optical cladding. These two parameters (i.e., the central core's diameter 2a and refractive index difference Dn) are chosen to control the effective index values n_{eff} of each wave participating in the sum-frequency generation process. Furthermore, the central core's diameter 2a and refractive index difference Dn can be controlled to increase the coherence length Lc. Thus, phase mismatch Δk may be reduced, and phase matching between waves ω₁, ω₂ and ω₃ is obtained.

For an efficient sum-frequency generating process, the phase mismatch Δk between input waves ω₁, ω₂ and output wave ω₃ should typically be less than about 10⁴ radians per meter (e.g., 10¹ to 10³ radians per meter, such as 10² radians per meter). Typically, the optical fiber's central core has a diameter 2a of between about 2 and 10 microns (e.g., between 2 and 3 microns). Typically, the optical fiber's central core has a refractive index difference Dn with optical cladding of between about 0.3 and 3 percent of optical cladding's refractive index (e.g., between about 2 and 2.5 percent).

The ranges of values for the central core's diameter 2a and refractive index difference Dn result in effective refractive indices for the waves ω₁, ω₂, and ω₃ that ensure a coherence length Lc greater than 300 microns (i.e., approximately equivalent to a phase shift of less than 10⁴ radians per meter). In some embodiments, the coherence length Lc can be greater than 10 centimeters. Thus, during a sum-frequency generating process, the waves of angular frequency ω₁, ω₂ and ω₃ are phase matched.

The effective refractive index n_{eff} of a wave also depends on wave propagation mode. Therefore, in some embodiments, different propagation modes are allowed for each of the input waves and the output wave in order to further increase the coherence length Lc.

The ranges of values for the central core's diameter 2a and refractive index difference Dn are generally representative of the optical fiber's theoretical profile (i.e., the set profile). Constraints in the manufacture of the optical fiber, however, may result in a slightly different actual refractive index profile. Under these conditions, it can be difficult to produce an optical fiber with sufficient accuracy in index-profile parameters in order to achieve a desired coherency length Lc.

In view of the foregoing, in some exemplary embodiments, the optical fiber's refractive index profile varies along its longitudinal axis. Thus, one can be certain that from one end to the other end, there is a point at which the fiber profile has the desired values. In other words, as a signal passes from one end of the optical fiber to the other end, it will pass through at least one point having the appropriate properties. Typically, the central core's diameter 2a can be diminished progressively from one end A of the optical fiber to another end B of the optical fiber. In other words, the core diameter 2a is tapered in the longitudinal direction of the optical fiber between two ends thereof.

This tapering concept can be better understood by referring to Tables 1 and 2, which provide characteristics of an optical fiber performing a frequency doubling application.

Table 1 (below) contains one exemplary refractive index profile making it possible to obtain phase matching for an incident wave of wavelength λ₁=λ₂=1064 nanometers and an output wave of wavelength λ₃=532 nanometers.

TABLE 1

| Fiber | | | n_{eff} LP01 @ | n_{eff} LP02 @ | |
|---|---|---|---|---|---|
| parameters | 2a (μm) | Dn (%) | 1064 nm | 532 nm | Lc (cm) |
| values | 2.450 | 2.13 | 1.463237 | 1.463239 | 13.3 |

Here, an optical fiber having a central core diameter 2a of 2.450 microns and an index difference Dn of 2.13 percent with respect to the optical fiber's optical cladding achieves effective indices of 1.463237 and 1.463239, respectively, for a wavelength of 1064 nanometers propagating in an LP01 mode and for a wavelength of 532 nanometers propagating in an LP02 mode. Thus, a coherence length Lc of 13.3 centimeters is achieved and, consequently, a phase mismatch of less than 10⁴ radians per meter.

Typically, when producing the optical fiber, the central core's diameter is controlled with a precision of 1/1000 (e.g., a core-diameter tolerance of 0.1 percent), which makes it possible to provide a coherence length Lc of about 10 centimeters.

In some optical-fiber embodiments that include a tapered core (i.e., a tapered central core diameter), for at least a portion of the optical fiber, the optical fiber's outer diameter may be substantially constant along a length of the optical fiber over which the central core's diameter is tapered (i.e., tapered core, constant optical fiber). Alternatively, for at least a portion of the optical fiber, the optical fiber's outer diameter may be tapered along a length of the optical fiber over which the central core's diameter is tapered (i.e., tapered core, tapered optical fiber).

Table 2 (below) contains an exemplary refractive index profile for the same application as the optical fiber of Table 1, but which accounts for manufacturing uncertainties.

TABLE 2

| | | | n_{eff} LP01 | n_{eff} LP02 | |
|---|---|---|---|---|---|
| | 2a (μm) | Dn (%) | @ 1064 nm | @ 532 nm | Lc (cm) |
| end A of the | 2.548 | 2.13 | 1.463990 | 1.464586 | 446 × 10⁻⁴ |
| fiber | | | | | |
| intermediate | 2.450 | 2.13 | 1.463237 | 1.463239 | 13.3 |
| position in | | | | | |
| the fiber | | | | | |
| end B of the | 2.352 | 2.13 | 1.462439 | 1.461944 | 537 × 10⁻⁴ |
| fiber | | | | | |

In some exemplary embodiments, the optical fiber of the present invention can exhibit a conical refractive index profile in its longitudinal direction. The ratio between the central core's diameter at one end of the optical fiber and the central core's diameter at the other end of the optical fiber may be between about 1 and 3, such as between 1 and 1.5. For example, the central core diameter 2a of the optical fiber in Table 2 progressively decreases from 2.548 microns at fiber-end A to 2.352 microns at fiber-end B. Tapering the central core's diameter ensures that, at an intermediate position between the fiber-ends A and B, the profile will have a central core diameter 2a of 2.450 microns, which allows a coherence length of 13.3 centimeters. Consequently, phase matching between the waves of wavelength λ₃ and λ₁ will occur.

The preferred value for the distance between fiber-ends A and B depends on (i) the attenuation of the optical fiber, (ii) the degree of the second-order nonlinear effect in the optical fiber, and (iii) the power of the incident signals. In effect, in an optical fiber without attenuation, for a given power of incident signals, the greater the distance between points A and B, the greater the efficiency of energy conversion of waves ω₁, ω₂ into the wave ω₃. Nevertheless, an optical fiber exhibiting signal attenuation limits the distance between points A and B. The order of magnitude of the preferred distance AB (i.e., the distance between fiber-ends A and B) is given by the attenuation length Lₐₜₜ, which can be determined by the equation: Lₐₜₜ=1/α, where α is the optical fiber's attenuation constant expressed in meters⁻¹.

For example, for an optical fiber having an attenuation of the order of 100 dB/km, the distance AB should be less than 100 meters (e.g., less than 30 meters).

In exemplary embodiments of the optical fiber, the metallic nanostructures may be inserted into the central core or the immediate vicinity of central core (i.e., the contiguous cladding). In these embodiments, reducing the diameter of the optical fiber's central core achieves a better overlap of the optical fiber's propagation modes with the metallic-nanostructure region(s), thereby improving the second-order nonlinear effect in the optical fiber.

Exemplary methods for incorporating metallic nanostructures into the optical fiber will be described more particularly with respect to an optical fiber having a germanium-doped-silica central core and gold nanoparticles having a 5-nanometer diameter.

In a first method, the porous core of an optical preform obtained by modified chemical vapor deposition (MCVD) can be first impregnated with a suspension (e.g., a solution) of manufactured gold nanoparticles. This is followed by calcination to eliminate the surface organic ligands. Calcination is a thermal treatment allowing the elimination of organic species coming from the impregnation solution. When nanoparticle suspensions are used, the nanoparticles often have organic ligands on their surface to allow them to stay in stable suspension (i.e., to avoid nanoparticle agglomeration and deposition that may be detrimental to the impregnation step).

Gold nanoparticle concentration and size can be controlled to obtain the desired degree of metal doping. The doped nanoparticle layer can then be agglomerated by sintering. The optical preform is reduced in diameter at 2200° C. prior to being drawn to form an optical fiber.

Another exemplary method for inserting gold nanoparticles includes initially incorporating metallic precursors (e.g., soluble metal salts) into the porous core of the optical preform. An annealing step under reducing conditions then makes it possible to generate the gold nanoparticles. This treatment can be applied before or after sintering the doped layer of the core. The metal can be reduced either using a chemical reducing agent incorporated with the metallic precursor, or by the action of a gas (e.g., a mixture of hydrogen (H₂) and an inert gas, such as helium (He), argon (Ar), or nitrogen (N₂)).

Those having ordinary skill in the art will understand that these are exemplary methods of inserting metallic nanostructures and that the metallic nanostructures may be inserted into optical fiber by any other suitable methods.

In another aspect, the present invention embraces a laser that includes at least a portion of an optical fiber having a central core, an optical cladding, and metallic nanostructures. In particular, the present invention embraces a laser emitting a wavelength in the visible range. In this regard, a laser emitting in the visible range that includes an optical fiber of the present invention typically has a nonlinear medium having strong second-order nonlinearity.

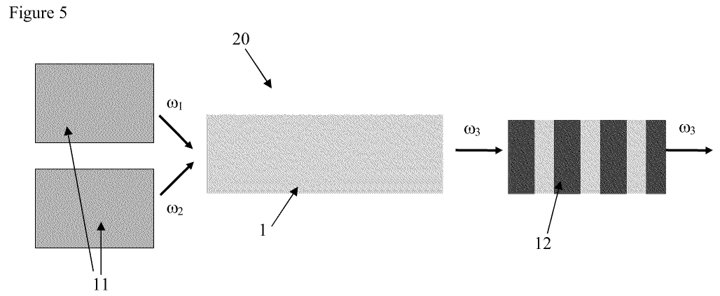

FIGS. 4 and 5 show examples of lasers 10 and 20, respectively, that include exemplary optical fibers 1 according to the present invention.

FIG. 4 is a diagram of a frequency doubling laser 10 that includes an optical fiber 1. The optical fiber 1 performs frequency doubling from a laser source 11 emitting a wave ω₁. The frequency doubling laser 10 can emit a wave ω₃ having a wavelength in the visible range. For example, a laser source 11 emitting a wave ω₁ of wavelength 1064 nanometers makes it possible to emit a wave ω₃ of wavelength 532 nanometers.

FIG. 5 is a diagram of a sum-frequency generating laser 20 that includes an optical fiber 1. The optical fiber 1 produces a sum of the frequencies of input waves ω₁, ω₂ from two pump laser sources 11.

Table 3 (below) provides typical examples of sum-frequency generation and frequency doubling in the visible range.

TABLE 3

| | Pump 1 | | | | | | |
|---|---|---|---|---|---|---|---|
| | | | | | | Telecom | |
| | | | 980 nm | | | Raman pump | |
| | 914 nm | 946 nm | laser | 1064 nm | 1342 nm | (example | 1550 nm |
| Pump 2 | DPSS | DPSS | diode | Yb laser | DPSS | 1480 nm) | Er laser |
| 914 nm DPSS | 457 | | | | | | |
| 946 nm DPSS | 465 | 473 | | | | | |
| 980 nm laser | 473 | 481 | 490 | | | | |
| diode | | | | | | | |
| 1064 nm | 492 | 501 | 510 | 532 | | | |
| DPSS or fiber | | | | | | | |
| laser | | | | | | | |
| 1342 nm | 544 | 555 | 566 | 593 | 671 | | |
| DPSS | | | | | | | |
| Telecom Raman | 565 | 577 | 590 | 619 | 703 | 740 | |
| pump (example | | | | | | | |
| 1480 nm) | | | | | | | |
| 1550 nm | 575 | 587 | 600 | 630 | 719 | 757 | 775 |
| Er laser | | | | | | | |

The examples of the lasers 10, 20 in FIGS. 4 and 5 can include an optical fiber 1 having a tapered (e.g., conical) profile in the longitudinal direction. In other words, the central core's diameter 2a diminishes progressively.

The examples of the lasers 10, 20 can also include a mode converter to modify the mode of the wave ω₃ leaving the optical fiber 1. For example, the mode converter can convert the wave ω₃ in LP02 mode to an ω₃ wave of mode LP01. The mode converter 12 may be a portion of optical fiber 12.

In the two examples of the lasers 10, 20 described (above), the laser sources 11 employed can be laser fibers, such as ytterbium (Yb) doped laser fibers. The mode converter 12 may be a long-period fiber grating. In this regard, the lasers 10, 20 including the optical fiber 1 are primarily constituted of fibers.

The frequency doubling laser 10 and the sum-frequency generating laser 20 that include the optical fiber 1 are inexpensive to produce when compared to the high added value of its components. The lasers 10, 20 are also compact and easy to integrate. The lasers 10, 20 are also reliable and robust and do not require complicated component design and alignment conditions.

The optical fiber can also be advantageously used in an optical amplifier.

This invention is not limited to the embodiments described by way of example. The optical fiber 1 can be installed in numerous transmission systems with good compatibility with the other fibers of the system.

To supplement the present disclosure, this application incorporates entirely by reference the following commonly assigned patents, patent application publications, and patent applications: U.S. Pat. No. 4,838,643 for a Single Mode Bend Insensitive Fiber for Use in Fiber Optic Guidance Applications (Hodges et al.); U.S. Pat. No. 7,623,747 for a Single Mode Optical Fiber (de Montmorillon et al.); U.S. Pat. No. 7,587,111 for a Single-Mode Optical Fiber (de Montmorillon et al.); U.S. Pat. No. 7,356,234 for a Chromatic Dispersion Compensating Fiber (de Montmorillon et al.); U.S. Pat. No. 7,483,613 for a Chromatic Dispersion Compensating Fiber (Bigot-Astruc et al.); U.S. Pat. No. 7,555,186 for an Optical Fiber (Flammer et al.); U.S. Patent Application Publication No. US2009/0252469 A1 for a Dispersion-Shifted Optical Fiber (Sillard et al.); U.S. patent application Ser. No. 12/098,804 for a Transmission Optical Fiber Having Large Effective Area (Sillard et al.), filed Apr. 7, 2008; International Patent Application Publication No. WO 2009/062131 A1 for a Microbend-Resistant Optical Fiber, (Overton); U.S. Patent Application Publication No. US2009/0175583 A1 for a Microbend-Resistant Optical Fiber, (Overton); U.S. Patent Application Publication No. US2009/0279835 A1 for a Single-Mode Optical Fiber Having Reduced Bending Losses, filed May 6, 2009, (de Montmorillon et al.); U.S. Patent Application Publication No. US2009/0279836 A1 for a Bend-Insensitive Single-Mode Optical Fiber, filed May 6, 2009, (de Montmorillon et al.); U.S. Patent Application Publication No. US2010/0021170 A1 for a Wavelength Multiplexed Optical System with Multimode Optical Fibers, filed Jun. 23, 2009, (Lumineau et al.); U.S. Patent Application Publication No. US2010/0028020 A1 for a Multimode Optical Fibers, filed Jul. 7, 2009, (Gholami et al.); U.S. Patent Application Publication No. US2010/0119202 A1 for a Reduced-Diameter Optical Fiber, filed Nov. 6, 2009, (Overton); U.S. Patent Application Publication No. US2010/0142969 A1 for a Multimode Optical System, filed Nov. 6, 2009, (Gholami et al.); U.S. Patent Application Publication No. US2010/0118388 A1 for an Amplifying Optical Fiber and Method of Manufacturing, filed Nov. 12, 2009, (Pastouret et al.); U.S. Patent Application Publication No. US2010/0135627 A1 for an Amplifying Optical Fiber and Production Method, filed Dec. 2, 2009, (Pastouret et al.); U.S. Patent Application Publication No. US2010/0142033 for an Ionizing Radiation-Resistant Optical Fiber Amplifier, filed Dec. 8, 2009, (Regnier et al.); U.S. Patent Application Publication No. US2010/0150505 A1 for a Buffered Optical Fiber, filed Dec. 11, 2009, (Testu et al.); U.S. Patent Application Publication No. US2010/0171945 for a Method of Classifying a Graded-Index Multimode Optical Fiber, filed Jan. 7, 2010, (Gholami et al.); U.S. Patent Application Publication No. US2010/0189397 A1 for a Single-Mode Optical Fiber, filed Jan. 22, 2010, (Richard et al.); U.S. Patent Application Publication No. US2010/0189399 A1 for a Single-Mode Optical Fiber Having an Enlarged Effective Area, filed Jan. 27, 2010, (Sillard et al.); U.S. Patent Application Publication No. US2010/0189400 A1 for a Single-Mode Optical Fiber, filed Jan. 27, 2010, (Sillard et al.); U.S. Patent Application Publication No. US2010/0214649 A1 for a Optical Fiber Amplifier Having Nanostructures, filed Feb. 19, 2010, (Burov et al.); U.S. patent application Ser. No. 12/765,182 for a Multimode Fiber, filed Apr. 22, 2010, (Molin et al.); U.S. patent application Ser. No. 12/794,229 for a Large Bandwidth Multimode Optical Fiber Having a Reduced Cladding Effect, filed Jun. 4, 2010, (Molin et al.); U.S. patent application Ser. No. 12/878,449 for a Multimode Optical Fiber Having Improved Bending Losses, filed Sep. 9, 2010, (Molin et al.); and U.S. patent application Ser. No. 12/884,834 for a Multimode Optical Fiber, filed Sep. 17, 2010, (Molin et al.).

To supplement the present disclosure, this application further incorporates entirely by reference the following commonly assigned patents, patent application publications, and patent applications: U.S. Pat. No. 5,574,816 for Polypropylene-Polyethylene Copolymer Buffer Tubes for Optical Fiber Cables and Method for Making the Same; U.S. Pat. No. 5,717,805 for Stress Concentrations in an Optical Fiber Ribbon to Facilitate Separation of Ribbon Matrix Material; U.S. Pat. No. 5,761,362 for Polypropylene-Polyethylene Copolymer Buffer Tubes for Optical Fiber Cables and Method for Making the Same; U.S. Pat. No. 5,911,023 for Polyolefin Materials Suitable for Optical Fiber Cable Components; U.S. Pat. No. 5,982,968 for Stress Concentrations in an Optical Fiber Ribbon to Facilitate Separation of Ribbon Matrix Material; U.S. Pat. No. 6,035,087 for an Optical Unit for Fiber Optic Cables; U.S. Pat. No. 6,066,397 for Polypropylene Filler Rods for Optical Fiber Communications Cables; U.S. Pat. No. 6,175,677 for an Optical Fiber Multi-Ribbon and Method for Making the Same; U.S. Pat. No. 6,085,009 for Water Blocking Gels Compatible with Polyolefin Optical Fiber Cable Buffer Tubes and Cables Made Therewith; U.S. Pat. No. 6,215,931 for Flexible Thermoplastic Polyolefin Elastomers for Buffering Transmission Elements in a Telecommunications Cable; U.S. Pat. No. 6,134,363 for a Method for Accessing Optical Fibers in the Midspan Region of an Optical Fiber Cable; U.S. Pat. No. 6,381,390 for a Color-Coded Optical Fiber Ribbon and Die for Making the Same; U.S. Pat. No. 6,181,857 for a Method for Accessing Optical Fibers Contained in a Sheath; U.S. Pat. No. 6,314,224 for a Thick-Walled Cable Jacket with Non-Circular Cavity Cross Section; U.S. Pat. No. 6,334,016 for an Optical Fiber Ribbon Matrix Material Having Optimal Handling Characteristics; U.S. Pat. No. 6,321,012 for an Optical Fiber Having Water Swellable Material for Identifying Grouping of Fiber Groups; U.S. Pat. No. 6,321,014 for a Method for Manufacturing Optical Fiber Ribbon; U.S. Pat. No. 6,210,802 for Polypropylene Filler Rods for Optical Fiber Communications Cables; U.S. Pat. No. 6,493,491 for an Optical Drop Cable for Aerial Installation; U.S. Pat. No. 7,346,244 for a Coated Central Strength Member for Fiber Optic Cables with Reduced Shrinkage; U.S. Pat. No. 6,658,184 for a Protective Skin for Optical Fibers; U.S. Pat. No. 6,603,908 for a Buffer Tube that Results in Easy Access to and Low Attenuation of Fibers Disposed Within Buffer Tube; U.S. Pat. No. 7,045,010 for an Applicator for High-Speed Gel Buffering of Flextube Optical Fiber Bundles; U.S. Pat. No. 6,749,446 for an Optical Fiber Cable with Cushion Members Protecting Optical Fiber Ribbon Stack; U.S. Pat. No. 6,922,515 for a Method and Apparatus to Reduce Variation of Excess Fiber Length in Buffer Tubes of Fiber Optic Cables; U.S. Pat. No. 6,618,538 for a Method and Apparatus to Reduce Variation of Excess Fiber Length in Buffer Tubes of Fiber Optic Cables; U.S. Pat. No. 7,322,122 for a Method and Apparatus for Curing a Fiber Having at Least Two Fiber Coating Curing Stages; U.S. Pat. No. 6,912,347 for an Optimized Fiber Optic Cable Suitable for Microduct Blown Installation; U.S. Pat. No. 6,941,049 for a Fiber Optic Cable Having No Rigid Strength Members and a Reduced Coefficient of Thermal Expansion; U.S. Pat. No. 7,162,128 for Use of Buffer Tube Coupling Coil to Prevent Fiber Retraction; U.S. Pat. No. 7,515,795 for a Water-Swellable Tape, Adhesive-Backed for Coupling When Used Inside a Buffer Tube (Overton et al.); U.S. Patent Application Publication No. 2008/0292262 for a Grease-Free Buffer Optical Fiber Buffer Tube Construction Utilizing a Water-Swellable, Texturized Yarn (Overton et al.); European Patent Application Publication No. 1,921,478 A1, for a Telecommunication Optical Fiber Cable (Tatat et al.); U.S. Pat. No. 7,702,204 for a Method for Manufacturing an Optical Fiber Preform (Gonnet et al.); U.S. Pat. No. 7,570,852 for an Optical Fiber Cable Suited for Blown Installation or Pushing Installation in Microducts of Small Diameter (Nothofer et al.); U.S. Pat. No. 7,526,177 for a Fluorine-Doped Optical Fiber (Matthijsse et al.); U.S. Pat. No. 7,646,954 for an Optical Fiber Telecommunications Cable (Tatat); U.S. Pat. No. 7,599,589 for a Gel-Free Buffer Tube with Adhesively Coupled Optical Element (Overton et al.); U.S. Pat. No. 7,567,739 for a Fiber Optic Cable Having a Water-Swellable Element (Overton); U.S. Patent Application Publication No. US2009/0041414 A1 for a Method for Accessing Optical Fibers within a Telecommunication Cable (Lavenne et al.); U.S. Pat. No. 7,639,915 for an Optical Fiber Cable Having a Deformable Coupling Element (Parris et al.); U.S. Pat. No. 7,646,952 for an Optical Fiber Cable Having Raised Coupling Supports (Parris); U.S. Pat. No. 7,724,998 for a Coupling Composition for Optical Fiber Cables (Parris et al.); U.S. Patent Application Publication No. US2009/0214167 A1 for a Buffer Tube with Hollow Channels, (Lookadoo et al.); U.S. Patent Application Publication No. US2009/0297107 A1 for an Optical Fiber Telecommunication Cable, filed May 15, 2009, (Tatat); U.S. patent application Ser. No. 12/506,533 for a Buffer Tube with Adhesively Coupled Optical Fibers and/or Water-Swellable Element, filed Jul. 21, 2009, (Overton et al.); U.S. Patent Application Publication No. US2010/0092135 A1 for an Optical Fiber Cable Assembly, filed Sep. 10, 2009, (Barker et al.); U.S. patent application Ser. No. 12/557,086 for a High-Fiber-Density Optical Fiber Cable, filed Sep. 10, 2009, (Louie et al.); U.S. Patent Application Publication No. US2010/0067855 A1 for a Buffer Tubes for Mid-Span Storage, filed Sep. 11, 2009, (Barker); U.S. Patent Application Publication No. US2010/0135623 A1 for Single-Fiber Drop Cables for MDU Deployments, filed Nov. 9, 2009, (Overton); U.S. Patent Application Publication No. US2010/0092140 A1 for an Optical-Fiber Loose Tube Cables, filed Nov. 9, 2009, (Overton); U.S. Patent Application Publication No. US2010/0135624 A1 for a Reduced-Size Flat Drop Cable, filed Nov. 9, 2009, (Overton et al.); U.S. Patent Application Publication No. US2010/0092138 A1 for ADSS Cables with High-Performance Optical Fiber, filed Nov. 9, 2009, (Overton); U.S. Patent Application Publication No. US2010/0135625 A1 for Reduced-Diameter Ribbon Cables with High-Performance Optical Fiber, filed Nov. 10, 2009, (Overton); U.S. Patent Application Publication No. US2010/0092139 A1 for a Reduced-Diameter, Easy-Access Loose Tube Cable, filed Nov. 10, 2009, (Overton); U.S. Patent Application Publication No. US2010/0154479 A1 for a Method and Device for Manufacturing an Optical Preform, filed Dec. 19, 2009, (Milicevic et al.); U.S. Patent Application Publication No. US 2010/0166375 for a Perforated Water-Blocking Element, filed Dec. 29, 2009, (Parris); U.S. Patent Application Publication No. US2010/0183821 A1 for a UVLED Apparatus for Curing Glass-Fiber Coatings, filed Dec. 30, 2009, (Hartsuiker et al.); U.S. Patent Application Publication No. US2010/0202741 A1 for a Central-Tube Cable with High-Conductivity Conductors Encapsulated with High-Dielectric-Strength Insulation, filed Feb. 4, 2010, (Ryan et al.); U.S. Patent Application Publication No. US2010/0215328 A1 for a Cable Having Lubricated, Extractable Elements, filed Feb. 23, 2010, (Tatat et al.); and U.S. patent application Ser. No. 12/843,116 for a Tight-Buffered Optical Fiber Unit Having Improved Accessibility, filed Jul. 26, 2010, (Risch et al.).

In the specification and/or figures, typical embodiments of the invention have been disclosed. The present invention is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

1. An optical fiber, comprising:
a central core comprising a core dielectric matrix, said central core adapted to transmit optical signals; and
an optical cladding comprising a cladding dielectric matrix, said optical cladding surrounding said central core and adapted to confine transmitted optical signals within said central core;
wherein said core dielectric matrix and/or said cladding dielectric matrix comprises metallic nanostructures for increasing second-order nonlinearity effects; and
wherein the optical fiber's phase mismatch Δk is less than 10⁴ radians per meter as defined by the relationship:
Δk=k3−k1−k2,
where k1 and k2 are wave vectors of a first incoming wave and a second incoming wave, respectively, and k3 is a wave vector of an output wave.

2. The optical fiber according to claim 1, wherein:
said core dielectric matrix comprises metallic nanostructures; and
the volumetric concentration of said metallic nanostructures in said central core is less than about 2 percent.

3. The optical fiber according to claim 1, wherein:
said optical cladding immediately surrounds said central core;
said cladding dielectric matrix comprises metallic nanostructures; and
the volumetric concentration of said metallic nanostructures in said cladding dielectric matrix is less than about 2 percent.

4. The optical fiber according to claim 1, wherein said metallic nanostructures comprise gold (Au), silver (Ag), copper (Cu), aluminum (Al), tungsten (W), nickel (Ni), palladium (Pd), rhodium (Rh), iridium (Ir), ruthenium (Ru), molybdenum (Mo), osmium (Os), and/or platinum (Pt).

5. The optical fiber according to claim 1, wherein most of said metallic nanostructures have an oval shape with a minor diameter and a major diameter, the minor diameter being oriented substantially perpendicularly to the longitudinal axis of the optical fiber.

6. The optical fiber according to claim 5, wherein the minor diameter is between about 1 nanometer and 200 nanometers.

7. The optical fiber according to claim 5, wherein the minor diameter is between about 5 nanometers and 100 nanometers.

8. The optical fiber according to claim 5, wherein the major diameter is between about 1 nanometer and 200 microns.

9. The optical fiber according to claim 5, wherein the ratio of the major diameter to the minor diameter is between about 1 and 2000.

10. The optical fiber according to claim 5, wherein the ratio of the major diameter to the minor diameter is between about 1 and 100.

11. The optical fiber according to claim 1, wherein:
said central core has a diameter of between about 2 microns and 10 microns; and
the refractive index difference Dn between said central core and said optical cladding is between about 0.3 percent and 3 percent.

12. The optical fiber according to claim 1, wherein:
said central core has a diameter of between 2 microns and 3 microns; and
the refractive index difference Dn between said central core and said optical cladding is between about 2 percent and 2.5 percent.

13. The optical fiber according to claim 1, wherein said central core's diameter is tapered along a length of the optical fiber.

14. The optical fiber according to claim 13, wherein:
said central core has a first core diameter at a first end of the optical fiber and a second core diameter at a second end of the optical fiber; and
the ratio of the first core diameter to the second core diameter is more than 1 and less than about 3.

15. The optical fiber according to claim 13, wherein:
said central core has a first core diameter at a first end of the optical fiber and a second core diameter at a second end of the optical fiber; and
the ratio of the first core diameter to the second core diameter is more than 1 and less than about 1.5.

16. The optical fiber according to claim 13, wherein the optical fiber has a substantially constant outer diameter along the length of the optical fiber over which said central core's diameter is tapered.

17. The optical fiber according to claim 13, wherein the optical fiber has a tapered outer diameter along the length of the optical fiber over which said central core's diameter is tapered.

18. The optical fiber according to claim 1, wherein the optical fiber has a coherence length (π/Δk) of at least about 300 microns.

19. The optical fiber according to claim 1, wherein the optical fiber has a coherence length (π/Δk) of at least about 10 centimeters.

20. An optical amplifier comprising at least a portion of the optical fiber according to claim 1.

21. A laser comprising at least a portion of the optical fiber according to claim 1.

22. The laser according to claim 21, comprising two pump laser sources.

23. The laser according to claim 21, comprising a portion of an optical fiber performing mode conversion.

24. The laser according to claim 21, wherein the laser emits electromagnetic radiation having a wavelength in the visible range.

25. An optical fiber, comprising:
a central core comprising a core dielectric matrix that includes metallic nanostructures for increasing second-order nonlinearity effects; and
an optical cladding comprising a cladding dielectric matrix, said optical cladding surrounding said central core;
wherein said central core's diameter is tapered along a defined length of the optical fiber; and
wherein the optical fiber's phase mismatch Δk is less than about 10⁴ radians per meter as defined by the relationship:
Δk=k3−k1−k2,
where k1 and k2 are wave vectors of a first incoming wave and a second incoming wave, respectively, and k3 is a wave vector of an output wave.

26. The optical fiber according to claim 25, wherein the optical fiber has a substantially constant outer diameter along the defined length of the optical fiber over which said central core's diameter is tapered.

27. The optical fiber according to claim 25, wherein:
said central core has a first core diameter at a first end of the optical fiber's defined length and a second core diameter at a second end of the optical fiber's defined length; and
the ratio of the first core diameter to the second core diameter is more than 1 and less than about 3.

28. The optical fiber according to claim 25, wherein the volumetric concentration of said metallic nanostructures in said central core is less than about 2 percent.

29. The optical fiber according to claim 25, wherein the volumetric concentration of said metallic nanostructures in said core dielectric matrix is less than about 2 percent.

30. The optical fiber according to claim 25, wherein:
said optical cladding immediately surrounds said central core; and
said cladding dielectric matrix comprises metallic nanostructures in a volumetric concentration of less than about 2 percent.

31. An optical amplifier or laser comprising at least a portion of the optical fiber according to claim 25.
